(19) United States
(12) Patent Application Publication
(10) Pub. No.: US 2015/0137557 A1
(43) Pub. Date: May 21, 2015

(54) Temperature-Controlled Personal Mobility Device Enclosure

(71) Applicant: Brandon Thomas, Delhi, LA (US)

(72) Inventor: Brandon Thomas, Delhi, LA (US)

(21) Appl. No.: 14/546,563

(22) Filed: Nov. 18, 2014

Related U.S. Application Data
(60) Provisional application No. 61/905,469, filed on Nov. 18, 2013.

(51) Int. Cl. B60H 1/00; B62D 31/00

(52) U.S. Cl. CPC B60H 1/00021; B62D 31/003; B60H 2001/00114
USPC 296/190.09

(57) ABSTRACT

A temperature-controlled enclosure that is attachable to a personal mobility device. The present invention comprises a frame that is attachable to a wheelchair, scooter, or other personal mobility device via welding, fasteners, or any other such method of attachment. The frame supports a hingedly attached cover, a power source, a heating unit, and a cooling unit. When users are excessively hot or cold, they can pull the cover down and activate either the heating unit or the cooling unit, as desired. When the cover is in its closed position, the cover and the frame create an enclosed space around the seat of the personal mobility device, trapping the heated or cooled air therein and thus providing relief to users from the surrounding environmental conditions.

### CROSS REFERENCE TO RELATED APPLICATION

This application claims the benefit of U.S. Provisional Application No. 61/905,469 filed on Nov. 18, 2013. The above identified patent application is herein incorporated by reference in its entirety to provide continuity of disclosure.

### BACKGROUND OF THE INVENTION

1. Field of the Invention

The present invention relates to a cooling and/or heating system for a personal mobility device, such as a powered wheelchair or scooter. More specifically, the present invention relates to a system for a personal mobility device that is adapted to cool and/or heat a user, while simultaneously protecting the user from surrounding environmental conditions.

2. Description of the Prior Art

Devices have been disclosed in the prior art that relate to cooling and/or heating systems for seats or electrically-powered personal mobility devices. Electrically-powered mobility devices, such as wheelchairs or scooters, that have heated or cooled seats are known in the prior art; however, this is a disadvantageous design because merely providing a heated or cooled seat may not be enough, without more, to make the user comfortable, especially on extremely hot or cold days. None of the devices currently known in the prior art comprise a hinged cover that, when in its closed position, provides an enclosed interior space to trap cold air and/or heat in order to improve the efficiency of the system and protect the user from the surrounding environmental conditions.

The present invention substantially diverges in design elements from the prior art and consequently it is clear that there is a need in the art for an improvement to existing heating or cooling systems for personal mobility devices. In this regard the instant invention substantially fulfills these needs.

### SUMMARY OF THE INVENTION

In view of the foregoing disadvantages inherent in the known types of personality mobility device temperature-control systems now present in the prior art, the present invention provides a new personality mobility device temperature-control system wherein the same can be utilized for providing convenience for the user when utilizing a personal mobility device during hot or cold weather conditions.

It is therefore an object of the present invention to provide a new and improved temperature-controlled personal mobility device enclosure that has all of the advantages of the prior art and none of the disadvantages.

It is another object of the present invention to provide a temperature-controlled personal mobility device enclosure that is attachable to a number of different personal mobility devices, such as powered wheelchairs and scooters.

Another object of the present invention is to provide a temperature-controlled personal mobility device enclosure that is adapted to complete enclose a user and protect the user from the elements of the surrounding environment.

Yet another object of the present invention is to provide a temperature-controlled personal mobility device enclosure that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the front portion of the present invention mounted to a wheelchair, with the cover in an open position.

FIG. 1B shows a perspective view of the front portion of the present invention mounted to a wheelchair, with the cover in a closed position.

FIG. 2 shows a perspective view of the back portion of the present invention mounted to a wheelchair.

### DETAILED DESCRIPTION OF THE INVENTION

Reference is made herein to the attached drawings. Like reference numerals are used throughout the drawings to depict like or similar elements of the temperature-controlled personal mobility device enclosure. For the purposes of presenting a brief and clear description of the present invention, the preferred embodiment will be discussed as used for a powered wheelchair. The figures are intended for representative purposes only and should not be considered to be limiting in any respect.

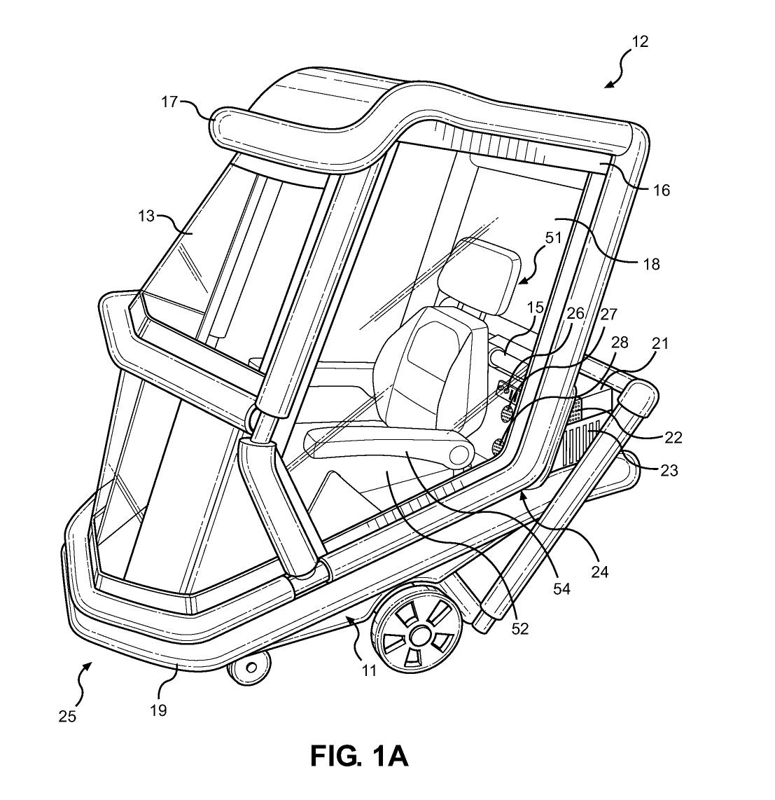

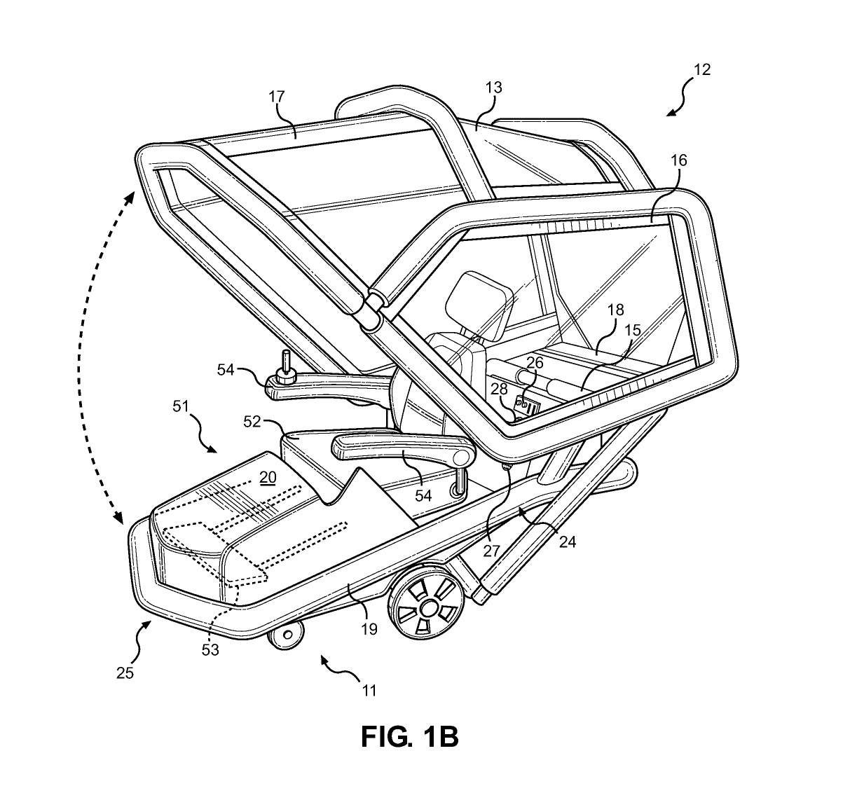

Referring now to FIGS. 1A and 1 B, there are shown perspective views of the front portion of the present invention mounted to a wheelchair, with the cover in an open and a closed position. The present invention comprises a housing 31 defined by a frame 11 adapted to be mounted to a personal mobility device 51, such as a powered wheelchair or a scooter, and a cover 12 attached to the frame 11. The cover 12 is attached to the frame 11 via a hinged connection 15, thereby allowing the cover 12 to transition between a raised, open position and a lowered, closed position. When in a closed position, the cover 12 and the frame 11 provide a substantially enclosed interior volume around an individual using the personal mobility device 51. The enclosed interior volume traps heat and/or cooled air generated by a heating unit 22 and a cooling unit 23, respectively, and prevents the heat and/or cooled air from escaping into the surrounding environment. The enclosed interior volume defined by the closed cover 12 and the frame 11 thereby provides relief to users by ensuring that they can remain properly heated or cooled, as desired, and also maximizes efficiency by ensuring that the thermal energy generated by the heating and cooling units 22, 23 is not wasted by being allowed to escape into the surrounding environment.

The frame 11 comprises a frame upper portion 24 and a frame lower portion 25. Each of the frame upper and lower portions 24, 25 are constructed from a plurality of frame members 19 that may be arranged in a number of different shapes and configurations depending upon the size and type of the personal mobility device 51 to which the present invention is mounted. In the depicted embodiment of the present invention, the frame upper portion 24 comprises a rectangular shape and an open interior area through which the seat 52 of the personal mobility device 51 is disposed. The frame bottom portion 25 comprises a plurality of frame member 19 extending from the personal mobility device seat 52 to footrest 53. A bottom surface 20 extends between the frame members 19 of the frame bottom portion 25, blocking air from flowing through the frame 11 via the open space between the seat 52 and the footrest 53 of the personal mobility device 51. The frame 11 provides a substantially enclosed bottom surface such that, when combined with the cover 12 in a closed position, the present invention provides a substantially enclosed volume.

The cover 12 of the present invention is hingedly connected 15 to the frame upper portion 24 and is adapted to pivot between an open position, in which the user is exposed, and a closed position, in which the user is completely enclosed. In the closed position, the cover 12 and the frame 11 form a substantially enclosed interior volume. The cover 12 comprises a pair of side portions 16, a front portion 17, and a rear portion 18 that is hingedly connected to the frame upper portion 24, above the heating unit 22, cooling unit 23, and power source 21. In the closed position, the edges of the side portions 16 and the front portion 17 of the cover 12 rest flush against the frame upper and lower portions 24, 25, ensuring that heated or cooled air cannot escape therethrough. The cover 12 is adapted to conform to the shape of the frame 11, which in turn is adapted to conform to the size and type of the personal mobility device 51 to which the present invention is mounted. Therefore, the cover 12 may be provided in a number of different sizes, shapes, and configurations as well in order to accommodate various sizes and types of personal mobility devices 51. The cover 12 further comprises one or more transparent windows 13 that allow for the user to see therethrough when the cover 12 is in its lowered, closed position so that the user can properly navigate the personal mobility device 51.

In an alternative embodiment of the present invention, the cover 12 comprises an upper cover portion and a lower cover portion that are hingedly connected together. In this embodiment of the present invention, the dual-hinge design for the cover 12 allows for the vertical height of the cover to be minimized when in its raised, open position. The hinged connection between the upper and lower cover portions causes the lower cover portion to extend horizontally from the upper cover portion when the cover 12 is raised, reducing the overall height of the cover 12. In another alternative embodiment of the present invention, the bottom edges of the side portions 16 and the front portion 17 of the cover 12 are padded to reduce the risk of injury from the cover 12 making contact with a user.

The frame 11 can be mounted to the personal mobility device 51 via welding or fasteners with brackets, or any other such means of attachment known in the prior art. The points at which the frame 11 is mounted to the personal mobility device 51 depend upon the size and type thereof. In one embodiment of the present invention, the frame upper portion 24 is mounted to the support beneath the personal mobility device seat 52. In another embodiment of the present invention, the frame upper portion 24 is mounted to the sides of the armrests 54. Furthermore, the frame lower portion 25 may be mounted to the personal mobility device footrest 53 in order to provide additional stability for the present invention. The frame 11 may be constructed from metal, such as aluminum, or other materials having suitable durability and weight-bearing properties.

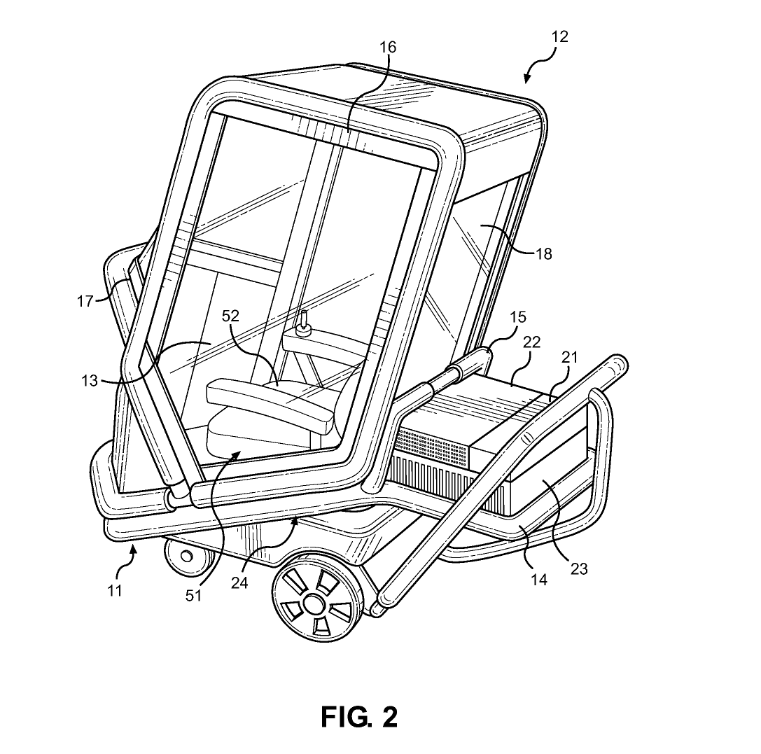

Referring now to FIG. 2, there is shown a perspective view of the back portion of the present invention mounted to a wheelchair. In the depicted embodiment of the present invention, the power source 21, heating unit 22, and cooling unit 23 are attached to the frame 11 via a support platform 14 that extends from the rear section of the frame upper portion 24. In this embodiment, the power source 21, heating unit 22, and cooling unit 23 are arranged in a stacked configuration. However, no claim is made as to the precise arrangement of the power source 21, heating unit 22, or cooling 23; nor is a claim made as to the precise means by which the power source 21, heating unit 22, and cooling 23 unit are attached to the present invention. For example, the power source 21, heating unit 22, and cooling unit 23 may be attached to the frame 11 or the cover 12 via fasteners or may be integrated directly into to the housing 31. The power source 21 is in electrical communication with the heating unit 22 and the cooling 23 unit and is adapted to control the operation thereof.

The power source 21 comprises a rechargeable battery, the integral power source of the personal mobility device 51, or any other such device adapted to provide sufficient electrical power to allow for the operation of the heating unit 22 and the cooling unit 23. The heating unit 22 comprises any electrical resistance-based heating device, such as a radiative heater. The cooling unit 23 comprises any electrically-driven device that is adapted to emit cooled air, such as an evaporative cooing unit akin to a conventional window-mounted air conditioning unit. The heating unit 22 and the cooling unit 23 each comprise an outlet 27, 28 positioned adjacently to the cover 12 such that when the cover 12 is in its closed position, the outlets 27, 28 are within the enclosed interior volume of the present. The heating unit outlet 27 emits heat generated by the heating unit 22 therefrom and the cooling unit outlet 28 emits cooled air generated by the cooling unit 23 therefrom. The thermal energy, whether in the form of heat or cooled air, emitted from the outlets 27, 28 is trapped within the interior volume of the present invention when the cover 12 is in its closed position. This ensures that the thermal energy is trapped therein for the user's benefit and is not allowed to escape therefrom into the surrounding environment.

The present invention further comprises users controls 26 disposed within the interior of the housing 31. The user controls 26 provide a means for users to control the functions of the power source 21, heating unit 22, and cooling unit 23. These functions include, but are not limited to, turning the devices on and off, controlling the temperature of the heat emitted by the heating unit 22, controlling the temperature of the cooled air emitted by the cooling unit 23, and turning a fan function or the heating unit 22 and/or the cooling unit 23 on and off. In an alternative embodiment, the present invention further comprises one or more electrical outlets disposed on the interior surface of the cover 12 of on the frame 11 that are in electrical communication with the power source 21. These electrical outlets provide a means by which other electronic devices, such as radios or music players, can be connected to the power source 21 and powered thereby.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A personal mobility device enclosure, comprising:
a frame that is attachable to a personal mobility device;
a cover hingedly attached to said frame, wherein said cover forms an enclosed interior volume when in a closed position;
a heating unit attached to said frame, wherein said heating unit comprises an outlet adapted to release heat into said enclosed interior volume;
a cooling unit attached to said frame, wherein said cooling unit comprises an outlet adapted to release cooled air into said enclosed interior volume;
a power source adapted to power said heating unit and said cooling unit.

2. The personal mobility device enclosure of claim 1, wherein said heating unit comprises a radiative heater.

3. The personal mobility device enclosure of claim 1, wherein said cooling unit comprises an evaporative cooler.

4. The personal mobility device enclosure of claim 1, wherein said cover comprises a transparent window.

5. The personal mobility device enclosure of claim 1, wherein said frame is mounted to said personal mobility device via one or more brackets.

6. The personal mobility device enclosure of claim 1, further comprising padding extending along one or more bottom edges of said cover.
